(19) United States
(12) Patent Application Publication
(10) Pub. No.: US 2006/0268913 A1
(43) Pub. Date: Nov. 30, 2006

(54) Streaming buffer system for variable sized data packets

(75) Inventors: Kanwar Jit Singh, Bangalore (IN); Dhiraj Kumar, Morristown, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/139,070

(22) Filed: May 27, 2005

(51) Int. Cl. H04L 12/28; H04J 3/24; H04L 12/56

(52) U.S. Cl. 370/412; 370/474

(57) ABSTRACT

A system for streaming incoming data packets into a buffer memory is presented. The system may receive incoming data packets over a variety of interfaces and separate the data packet into a header page and one or more data page. The system may interface with a header processor and send header pages to the header processor to be modified. Data pages from the incoming data packets are streamed to a central staging memory, allowing the use of a simple first-in-first-out (FIFO) buffer. The system may receive modified headers from the header processor and provide multiple copies of data packets for multicast or sampling purposes. Data packet copies may then be written to an external memory buffer over one or more external memory channels. The system may also provide an error recovery process to account for corrupt data packets streamed to the external memory buffer.

### FIELD

The present invention relates to the field of memory buffers for streaming data. More specifically, the present invention relates to network systems that receive packetized data over multiple interfaces and are able to replicate and buffer the data in memory for subsequent transmission.

### BACKGROUND

Digital communication networks allow large amounts of electronic information to be rapidly transferred from a source node to one or more destinations. The scope and complexity of these networks range from simple point-to-point networks that consist of a direct-linked cable, to large inter-continental digital networks with millions of internal and external nodes. In the simplest of digital networks, data is sent directly from the source to its destination with no intermediate stops. However, in the case of more complex networks data packets may pass through several different internal network nodes, or network routers, before reaching their final destination.

The general function of these network routers is to receive data packets from various data streams and forward these packets towards their respective destinations. These network routers may receive data from multiple sources on multiple incoming interfaces, perform a certain amount of processing on each of the data packets, and then route the data packets to other intermediate or final destinations on one or more outgoing interfaces. The processing performed on the data packet by the router is determined in part by the capabilities of the router and the type of network, but generally includes error checking and header interpretation and manipulation. For most data transfer protocols, and for internet protocol (IP) standards, a data packet comprises a header followed by a data payload. The header may include such information as the data packet source address, the destination address, various control bits, desired transfer routes, and multicast or broadcast specifications.

Certain routers follow a general procedure in order to process and forward data packets received at an incoming interface. Depending on the capabilities of the router, the entire data packet may need to be received before any processing of the data packet can begin. First the header is stripped from the data payload of the data packet, with the header being copied to a header processor and at least a portion of the data packet being sent to a dedicated incoming buffer assigned to the incoming interface. The data payload and its header may be stored in another on-chip buffer until the header processor returns a corresponding modified header. The header processor may alter the destination address of the header, drop the header from the system, or create multiple instances of the header for multicasting or sampling purposes. Once a modified header is returned from the processor, the corresponding data payload may be retrieved from the on-chip buffer, recombined with the modified header, and stored in a larger external buffer. The system then retrieves the modified header and data payload from the external buffer and outputs the data over the proper interface.

With the general process above, depending on the size of the data payload and the processing time required by the header processor, a modified header may need to wait for the entire data payload to be buffered on-chip before the data packet can be output from the router. Additionally, buffering an entire data packet when it is initially received, or buffering an entire data payload while a header is being processed may require substantial amounts of on-chip buffer memory space. The use of multiple buffers for each incoming interface also increases the amount of on-chip buffer space required while possibly limiting incoming buffer efficiency.

As a result of the above limitations, it would be desirable to have a buffering system in a data packet router or switch that is capable of handling packets of variable lengths arriving on multiple ports or interfaces. In addition to handling multiple data streams, it would be desirable for the router to be able to buffer data in an external memory for later use, in order to fulfill quality-of-service (QoS) specifications. It would also be desirable for a system to be able to begin processing a data packet as soon as the data header packet is received, in order to limit the amount of incoming and on-chip buffer space required. Finally, such a system should also be able to multicast on a packet-to-packet basis.

### BRIEF DESCRIPTION OF THE DRAWINGS

Exemplary embodiments of the invention are described below in conjunction with the appended figures, wherein like reference numerals refer to like elements in the various figures, and wherein:

FIG. 1 is a schematic of a data network packet router buffering system according to an embodiment;

FIG. 2 is an illustration of the function of page formation units and an interleaver unit in a data network packet router buffering system having three active incoming interfaces, according to an embodiment;

FIG. 3 is a schematic showing the initial processing performed on a packet-start page to produce a modified header and corresponding descriptor;

FIG. 4 is a modified header descriptor comprising relevant information related to modified header entries, according to an exemplary embodiment;

FIG. 5 is a page descriptor that comprises relevant information related to stored data pages, according to an embodiment;

FIG. 6 is a central memory structure comprising a modified header memory structure and a page data memory structure, according to an embodiment;

FIG. 7 is a flow diagram illustrating a general function of the request generator, according to an embodiment;

FIG. 8 is a write processor request generated by a request generator, according to an embodiment;

FIG. 9 is a service request generated by a write processor, according to an embodiment;

FIG. 10 is a write configuration packet generated by the write processor, according to an embodiment; and

FIG. 11 is a diagram illustrating the process of merging a modified header with an original packet-start page to create a set of final packet-start pages.

### DETAILED DESCRIPTION

1. System Overview

The current invention describes a system in a network router or switch for streaming incoming packet data into a buffer. The described system is capable of performing header processing on data packets as soon as the header portion of the packet arrives, as opposed to requiring the entire data packet to be stored locally before attempting any manipulation of the header for routing purposes; this allows for faster throughput and greater buffering speed of incoming network data packets. Additionally, the system is capable of processing and buffering packets received over multiple interfaces. The system also allows for a more efficient use of memory buffers by utilizing a central staging area for incoming data packets, as opposed to utilizing multiple buffers corresponding to each individual incoming interface. Additionally, the system described herein is capable of identifying errors in packet data at multiple points throughout the buffering process which is necessary due to the streaming nature of the system.

The buffering system is the component of the router responsible for receiving and storing data in a buffer for later retransmission to another intermediate or final destination. Data packets may arrive over one or more incoming interfaces. These data packets are generally portions of a larger and more complete data stream. These data streams may represent data files and messages, such as digital documents, photos, or e-mails. Additionally, these data streams may represent actual streaming digital audio or video data. The data streams may be broken into one or more data packets during transmission over the network, with each data packet comprising a header and a data payload.

The header generally comprises a variety of information regarding the packet destination, source, and length of the data payload. Depending on the transfer protocol being used, other values may also be present in the header that pertain to, for example, multicast settings, broadcast settings, replication, error detection and correction, authentication, and sequencing. While the data payload is generally not altered by the router, the header may undergo significant processing and modification. Generally, the router will examine the source and destination addresses and utilize this information to route the data packet to the proper intermediate or final network node via the proper output port. Because a router may bridge networks using different data transfer protocols, the entire header may need to be reformed in order to reach this subsequent network node. Additionally, in the case of data packets with multicast or broadcast settings, entirely new modified headers may need to be generated to direct copies of the data payload to the desired destinations.

The buffering system of the present invention receives internet data packets over one or more interfaces, processes the headers of the data packets, and then stores the modified data packets along with any required copies into a memory. Once in the memory, these modified data packets can then be forwarded to the next destination when the outgoing ports interfaces are available. Because the data and their copies are stored in memory, in certain embodiments it may be possible to select the order in which data packets are sent out over an external interface, thereby helping to ensure necessary Quality of Service (QoS) levels.

2. System Specification

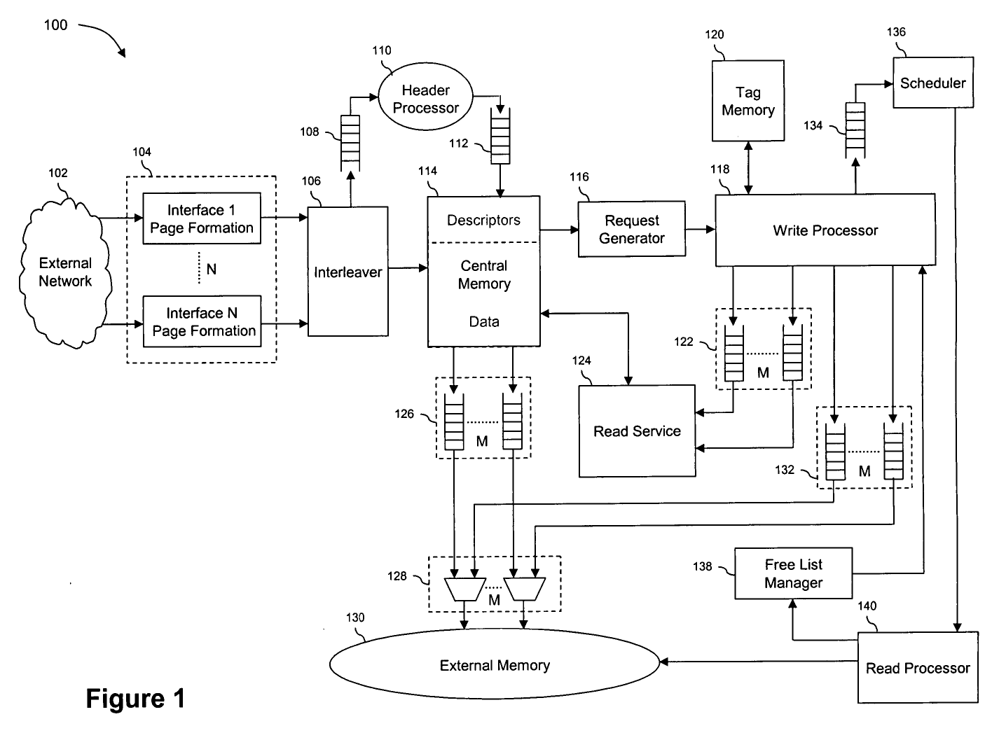

In the system of the present invention, data packets are received at one or more interfaces where page formation takes place. The system shown in FIG. 1 contains N incoming port interfaces 104, with each interface having a page formation unit. The incoming data packets on each interface are partitioned into pages of a substantially fixed size by the interface page formation units 104. The size to which most of the data packets are partitioned is substantially equal to the page size of the external memory buffer, less any space required for memory control bits and pointers. An exception to this fixed partitioning may occur with the first page formed from the data packet; in order to prevent fragmentation of the data packet header, the first data page formed from the data packet may be larger than the page size in the external buffer memory. In one embodiment, the first data page, or packet-start page, may be substantially twice the page size of the buffer in the external memory 130, less any space required for memory control bits and pointers. Alternatively, another multiple of the external memory buffer page size may be used, or a non-multiple may be used that is large enough to ensure packet headers are not fragmented. The larger first page may later be broken into one or more segments by the request generator unit 116. For example, if the page size of the buffer in the external memory is 64 bytes, each packet may be partitioned into 60-byte pages with the packet-start page size being 120 bytes (multiples of the external buffer page size, less 4 bytes per every 60 bytes in order to allow for the later addition of a memory pointer and various control bits). In addition to partitioning data packets, the interface page formation units 104 may also be capable of detecting physical errors in a given data packet. If an error is present, all subsequent data belonging to the faulty data packet is dropped. Due to the streaming nature of the system, however, the data packet pages created by the page formation units 104 prior to the detection of the faulty page may have already entered the system and been stored in an external memory buffer. As is described below, these defunct pages belonging to the faulty data packet are detected later in the system pipeline and can be dropped through the use of an error-recovery or clean-up procedure.

As the data packet pages are created by the interface page formation units 104, they are passed to an interleaver unit 106 which acts to multiplex the multiple interface data streams into a single first-in-first-out (FIFO) buffer, thereby creating a single data stream. The pages are written into the interleaver unit in the order in which they arrive. If a single incoming interface is active, then the pages for that data packet are simply written to the interleaver in sequential order. If multiple incoming interfaces are actively receiving and paging data simultaneously, the interleaver may perform a round robin and accept pages as they become available. As a result, pages belonging to the same data stream, and therefore arriving on the same interface, will always be written to the interleaver in order, although they may not be written sequentially. Also within the interleaver unit may be a data description FIFO that contains descriptors corresponding to the received data packet pages. These initial data descriptors may comprise such information regarding the data pages such as: the incoming interface (INT) on which the data payload page was received; the type of data page (P_TYPE), which may be the start of the packet (packet-start), the end of the packet (packet-end), or a continuing segment in a packet (packet-continuation); and the length of valid data bytes in the page (P_VALID).

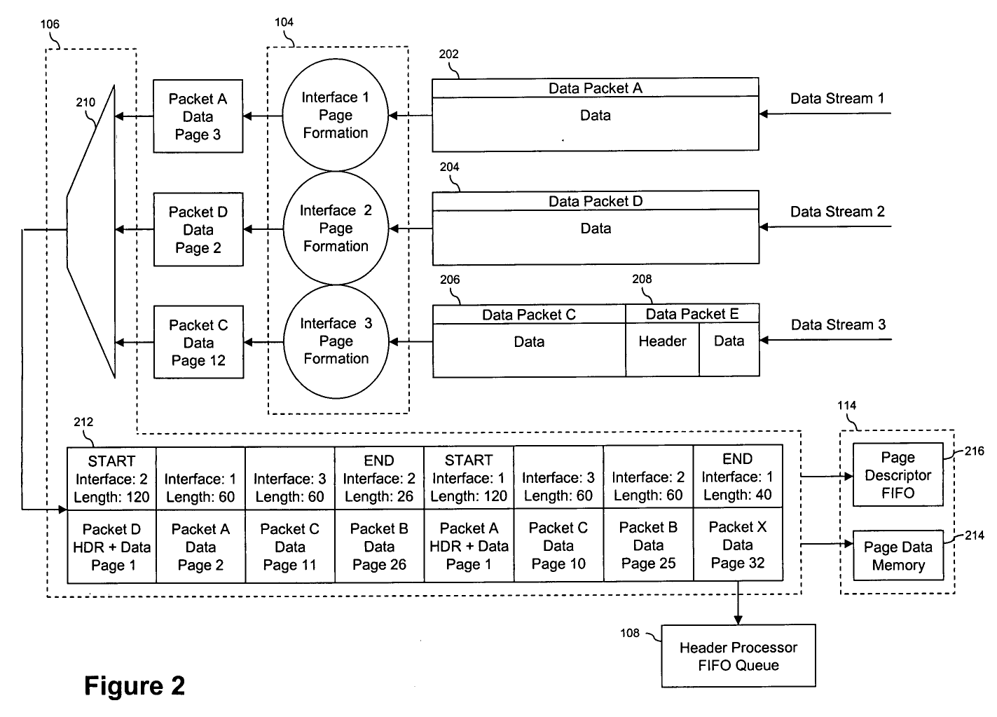

FIG. 2 illustrates the functionality of both the interface paging units and the interleaver unit. Three incoming interfaces are shown in the illustration, each actively receiving data packets corresponding to one of three data streams. Data packet A 202, data packet D 204, and data packet C 206 are in the process of being received and partitioned by the page formation units, with data packet E 208 following the transmission of data packet C 206 in data stream 3. In the example shown, the interface page formation units 104 generally separate the packets into data chunks of 60 bytes, with each packet-start pages having a length of 120 bytes. After a page is created from a packet, it is sent to the interleaver unit 106. Upon entering the interleaver unit the pages are multiplexed into a single stream and input into an interleaver FIFO queue 212. In one embodiment the system may use a round robin scheme on the available incoming interfaces in order to multiplex the pages. Additionally, a corresponding data descriptor is generated and grouped with the page data prior to the data being multiplexed and stored in the interleaver FIFO queue 212. In the example shown and as described above, each descriptor comprises information pertaining to the type of page, whether it is a data packet-start (START), data packet-end (END), or a continuation. The descriptor may also comprise information regarding the interface that the page arrived on and the length of the data in the page. Other information may also be contained in this header to help identify and group packets, such as a unique data packet identifier for sequential packets arriving over the same interface. At the exit of the interleaver FIFO queue 212, all data pages are sent to a page memory to await processing of their corresponding header. Additionally, all data packet-start pages, which comprise the data packet headers, are copied and sent to a header processor queue 108 to await processing by a header processor 110.

As described above in the illustration of FIG. 2, the interleaver 106 separates the packet-start page from the data payload pages during the paging process and sends a copy of the former to a separate dedicated FIFO queue 108 that feeds into a header processor 110. Prior to placing the data packet-start pages in the FIFO queue 108, the interleaver 106 may also append or prefix a header sequence number (SEQ) to each data packet-start page. This sequence number may be used at a later point for error detection and also to distinguish multicast packets. In general, each packet-start page may be assigned a unique sequence number, limited by the number of bits used to represent the sequence number. In one embodiment, eight bits may be used to represent the sequence number, with the assigned sequence number incremented for each packet-start page sent to the header processor 110 and looping back to zero after reaching a maximum value of 255. In certain embodiments, the sequence number assigned to a packet-start page may also be attached to page descriptors from the same data packet; this may facilitate the removal of data from the central memory in the case of a dropped packet-start page.

The header processor 110 may generally be capable of handling a variety of headers conforming to multiple transfer protocol header formats. For each data packet-start page that the header processor 110 receives, it may output one or more modified headers comprising a number of header bytes that are partially or completely modified. The type of processing performed by the header processor 110 may depend on variables inherent to the type of network that the router is connected to, as well as specific characteristics of the packet header itself. For example, the header processor may generally decrement any time-to-live (TTL) values, or check and update any checksum values. Additionally, multiple modified headers may be generated from a single original packet-start page in the presence of broadcast or multicast settings. If no modification of the header in the packet-start page is required, the header processor 110 may simply return a control message, or descriptor, indicating that the original header is to be used. Finally, in addition to providing forwarding and replicating commands, the header processor may determine if a data packet is valid or invalid, and generate commands for the request generator to drop invalid data from the system. Instances in which the header processor may designate a data packet as invalid and request packet data pages be dropped from the system may include a faulty checksum in the header, the presence of a broadcast header directed to a network that prohibits broadcast packets, or a set Don't Fragment (DF) bit in the header of a packet whose size exceeds the MTU of the network system on the outgoing interface, or in the case the header processor has a policing ability and determines that the data flow over a certain interface exceeds a maximum rate. In order to facilitate processing of the modified headers, and to allow for control information to be passed to the request processor, the header processor 110 may return a corresponding modified header descriptor for each of the modified headers, the content of which is further described below.

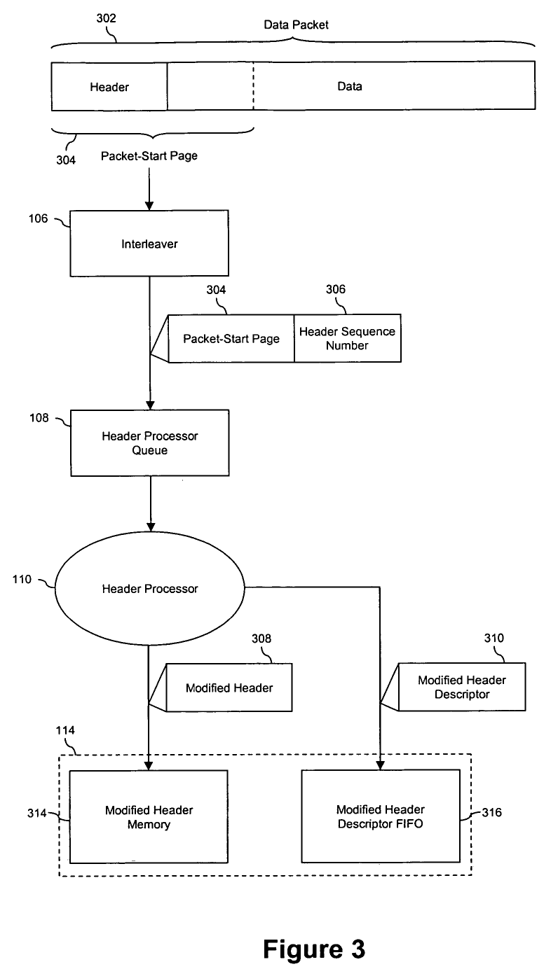

FIG. 3 shows the processing of packet-start pages in greater detail. Once a data packet 302 is paged, the interleaver 106 creates a copy of the packet-start page 304, appends a sequence number 306 to the packet-start page, and then places this data into the header processor queue 108. When the header processor 110 is ready, it retrieves the next packet-start page and header sequence number from the FIFO queue 108 and processes this data. The header processor 110 then generates one or more modified headers 308 along with one or more modified header descriptors 310 corresponding to the returned modified headers. The modified headers are sent to a modified header memory 314 while the modified header descriptors are sent to a modified header descriptor FIFO structure 316.

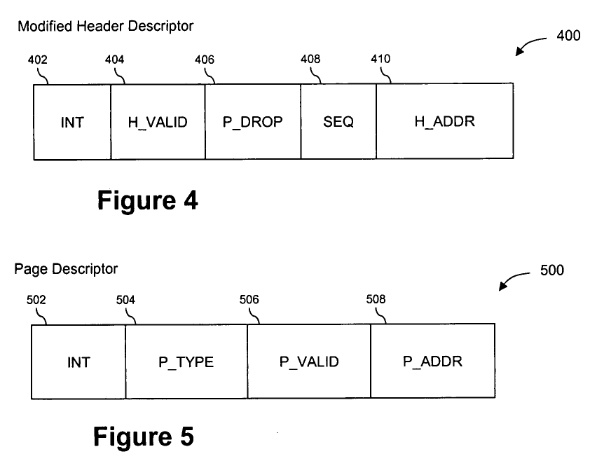

As shown in FIG. 4, each modified header descriptor 400 may comprise the incoming interface (INT) 402 of the packet from which the modified header derives, the number of valid bytes (H_VALID) 402 in the modified header entry, the number of bytes that should be dropped (P_DROP) 404 from the initial portion of the original packet-start page during merging, the header sequence number (SEQ) 408, and the memory address (H_ADDR) 410 of the modified header in the modified header memory. The H_VALID and P_DROP entries may be utilized when the modified header is merged with the original packet-start page prior to being written to the external memory; if no modification to the header or the original packet-start page is necessary, both H_VALID and P_DROP may be set to zero. As described above, the header sequence number entry 406 is assigned to the packet-start page by the interleaver and is utilized to determine multicast packets and detect dropped data packets. Additionally, other information may be included in the modified header descriptor, such as the total length of valid data in the original packet-start page (P_VALID). The stored modified header descriptors may subsequently be utilized by a request generator 116 to determine the number of copies of a given data packet that are required, as well as to assign a tag descriptor for each of these copies. In addition, the information contained in the modified header descriptors may be utilized to read portions of modified header pages from a temporary memory and merge them with corresponding original packet-start pages. As described above, the modified headers and the modified header descriptors may be written to a modified header memory buffer 314 and a modified header descriptor FIFO 316, respectively.

With the packet-start page of a data packet copied out to the header processor 110, the interleaver 106 writes the corresponding packet pages to a page memory 214 in the order in which the pages entered the interleaver page FIFO 216. As a result, the order of the pages in the interleaver is preserved in the page memory 214. As described above, when a data page is written into the page memory, its corresponding data descriptor may be written into a page descriptor FIFO 216 that also preserves the order of the data pages written into the page memory. The page descriptors written into the page descriptor FIFO are similar to those generated during the interleaving process, but also include the address of the corresponding data page in the page memory (PADDR). As shown in FIG. 5, each page descriptor entry 500 may comprise such information as the interface 502 on which the data page was received, the type of page 504, the length of valid data 506 in the page, and the address 508 of the corresponding data page in the page data memory. The type of page designated by the P_TYPE entry 504 may be a data packet-start, data packet-end, or data packet-continuation, each of which may be represented by a unique combination of bit values. As above, the P_VALID entry 506 denotes the length of valid data in the corresponding data packet page, and may or may not be equal to the page length of the page data memory. The page descriptors in the page descriptor FIFO may be used later for error detection and for grouping data packet pages together when writing packet data to the external memory 130. This page descriptor FIFO 212 may be located within the same physical memory structure as the page data memory 214, and in the central memory unit 114. Alternatively, the page memory 214 and the descriptor FIFO 216 may be contained in a separate buffer structures.

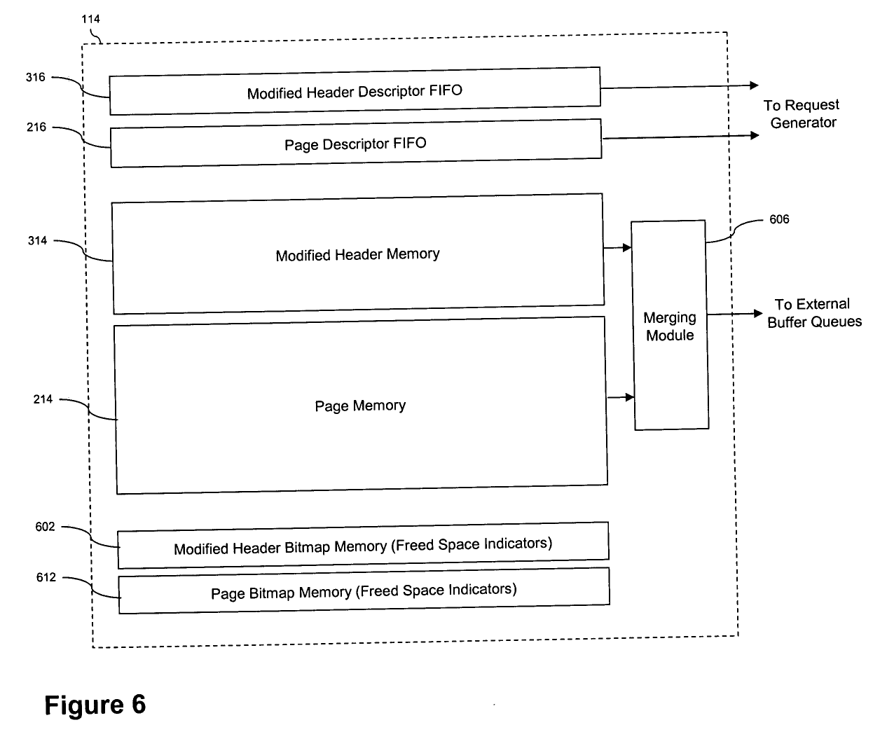

As shown in FIG. 6, the memory buffers and queues for the header and page data may all be located within a central memory unit 114. This memory unit may comprise separate structures for header related data and packet page related data. The central unit may comprise page data memory 214 and page descriptor FIFO 216 to store page data and their corresponding descriptors, respectively, and may comprise modified header memory 314 and modified header descriptor FIFO 316 to store modified header entries and their corresponding descriptors, respectively. Additionally, the central memory structure may comprise a page data bitmap memory 602 and a modified header bitmap memory 612, which may be used to track the free space in the page data memory 214 and the modified header memory 314, respectively. The manner in which the two bitmap memories 602, 612 are utilized to track unused memory segments in the buffers 214, 314 is further described below. In addition to the various memory components, the central memory unit 114 may also comprise a merging module 606 that may be utilized to merge modified header data with original packet-start data pages, as further described below.

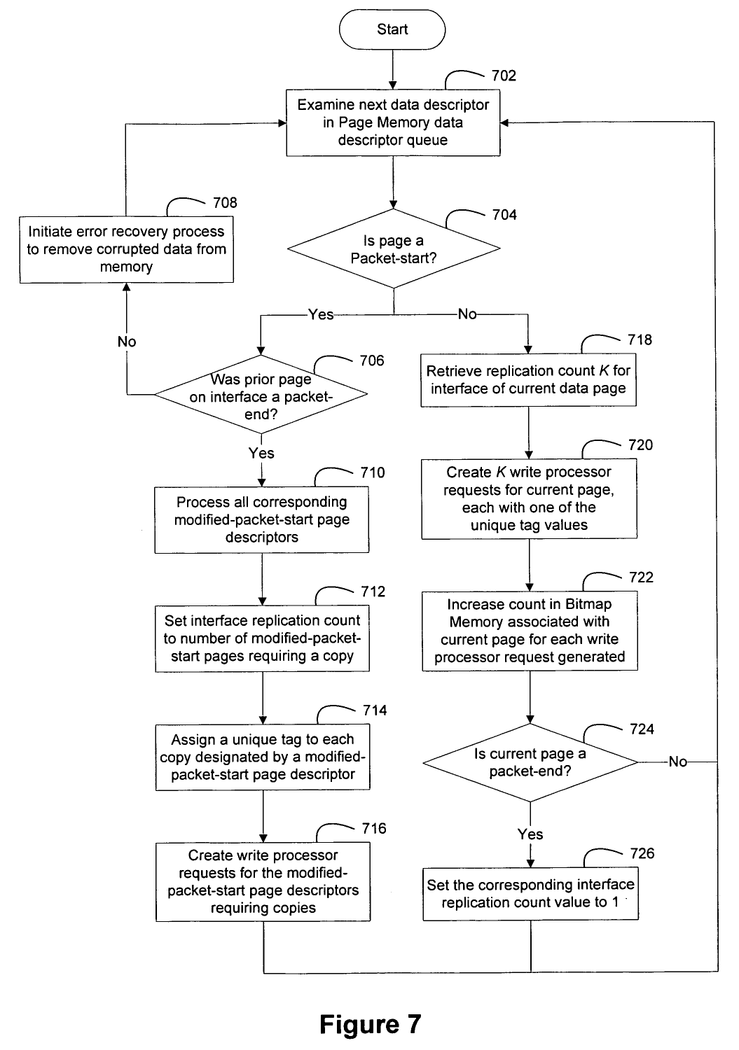

The descriptors from both the page descriptor FIFO 216 and the modified header descriptor FIFO 316 are subsequently passed to a request generator 116. In general, the request generator 116 sends write requests to a write processor 118. However, the type of page and the order in which it is received may affect the manner in which the request generator handles each data page. The request generator 116 may determine the proper method for processing a given data page using a procedure similar to the one illustrated in FIG. 7. The request generator 116 retrieves the next available page descriptor from the page descriptor FIFO 216, and uses this page descriptor to determine the properties of the corresponding data page in the page memory 214. The page descriptor is examined to determine the value of P_TYPE, which may be packet-start page, packet-end page, or packet-continuation page 702. If the referenced data page is the start of a data packet 704, the request generator 116 may examine the modified header descriptors present in the modified header descriptor FIFO 316. For a given data packet, a certain number of sequential corresponding packet-start page descriptors may be retrieved from the modified header descriptor FIFO 316. Of these modified header descriptors, K may correspond to multicast headers that require copies of the data pages stored in the page memory. A replication count of K is maintained for the interface corresponding to the number of valid modified header descriptors received that are associated with a single multicast packet 712, and this count may be used to determine the number of copies that are required for each data page associated with the multicast packet on that interface. These K modified header descriptors are each assigned a unique tag identifier (TAG) 714 and are then formed into write processor requests and forwarded to the write processor 716. As further described below, the TAG entry is used to distinguish data pages from a single data packet that belong to separate copies of that packet. The generated write processor requests are used to retrieve the modified header data from the header data memory 324, wherein this data is subsequently merged with the corresponding original start packet page data, linked to the corresponding packet data pages, and then written out to an external buffer memory 730.

Multicast packets may be identified by the request generator by the presence of multiple similar SEQ values in the modified header descriptors. For example, if several sequential modified header descriptors have the same SEQ value, it can correctly be determined that these modified headers all derived from the same original start-packet page. The pattern of SEQ values in subsequent modified header descriptors may also be used to determine if a data packet has been dropped by the header processor. Since SEQ values are assigned sequentially and the header processor processes original start-packet pages sequentially as well, if the series of SEQ values in subsequent modified header descriptors has a gap it can be determined that the original start-packet page has been dropped and that any stored data corresponding to the original start-packet page should be removed from the age memory. For example, if a partial series of SEQ values in subsequent modified header descriptors retrieved by the request processor is “5, 5, 6, 7, 8, 8, 8, 10” then it can be determined that the data associated with the original start-packet page that received the SEQ value of “9” should be dropped.

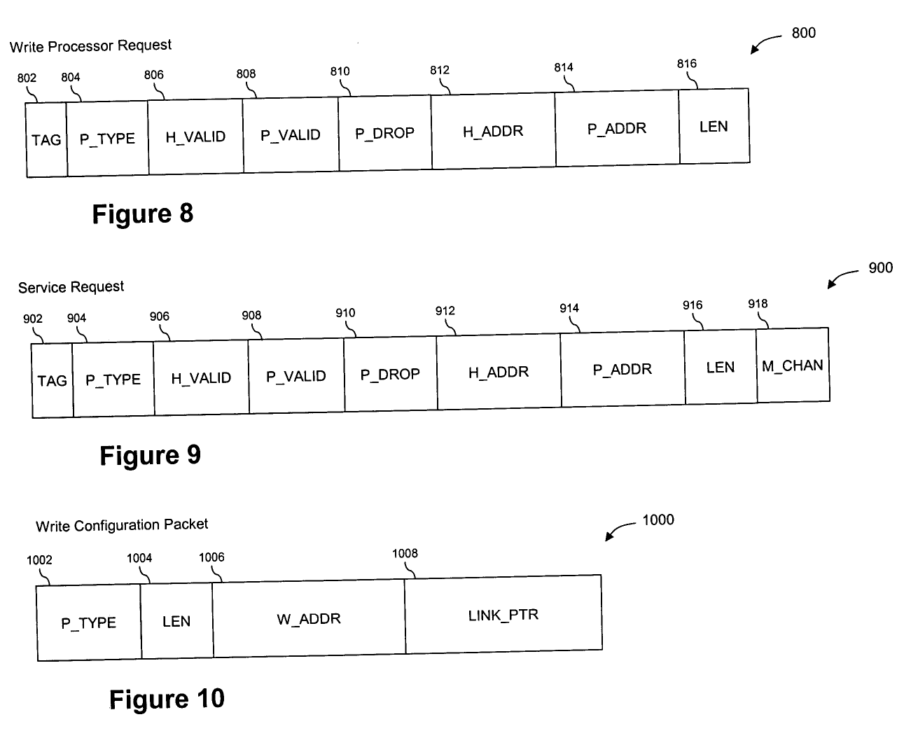

The request generator 116 stores the replication count K and utilizes this value to determine the number of write processor requests to send to the write processor 118 for each data page stored in the central memory buffer 114. Each write processor request may correspond to data entries to be retrieved from the page memory, modified header memory, or both. FIG. 8 illustrates the composition of a write processor request message according to one embodiment. Each write processor request 800 may comprise: a TAG field 802; a P_TYPE field 804, which may be packet-start, modified-header, packet-end, or packet-continuation; a H_VALID field 806 that designates the amount of valid header data in the modified header entry to be retrieved from the modified header memory; a P_VALID field 808 that designates the amount of valid page data in the data page entry to be retrieved from the page memory; a P_DROP field 810 that designates the amount of page data to be dropped from the data page entry retrieved from the page memory; a H_ADDR field 812 that designates the modified header memory address of any modified header data; a P_ADDR field 814 that designates the page memory address of any page data; and a LEN field 816 that designates the length of the final data segment to be retrieved from memory.

Generally, the H_VALID, P_DROP, and H_ADDR entries may be similar to those of any corresponding modified header descriptors. Likewise, the INT, P_TYPE, P_VALID, and P_ADDR entries may be similar to those of corresponding page descriptors. However, all of the above values are generally manipulated when the write processor merges modified eaders with packet-start pages. Generally, of the two data memory address fields 812, 814 only one may comprise a valid memory address; there may be a single page memory address when the write processor request corresponds to a packet-end or packet-continuation type packet, or a single modified header memory address when the write processor request corresponds to a modified header type packet; however, when the request corresponds to packet-start page, both address fields may comprise data in order to permit the merging of modified header and original packet-start page data at a later stage of the buffering process.

As stated above, the replication count K is utilized to determine the number of write processor requests to generate for a given data page until a packet-end page identifier for the corresponding interface is retrieved from the data descriptor queue. Generally, there need only be a maximum of N separate replication count values stored by the request generator at any given time, where N is the number of incoming interfaces and where each replication count value is associated with a single incoming interface. Additionally, the request generator 116 may maintain a table of the unique tag identifiers assigned to the modified headers of each interface. Each of the K write processor requests issued for a data page of a given interface may be assigned one of these unique tag identifiers. In a given embodiment, if the maximum replication count per data packet is set at K′ then the maximum number of unique tag identifiers required by the system is substantially K′×N.

The request generator 116 may also partition larger packet-start pages into smaller segments that may be stored in the external buffer memory. This may be accomplished by manipulation of one or more of the fields in write processor request messages. The request generator may first determine if a given page is a packet-start page, and then further determine if the page exceeds the page size of the external buffer memory. If an examined data page meets these criteria, the request generator may issue two or more write processor requests, with each request corresponding to a sequential subsection of the data page that is within the page size of the external buffer memory. For example, if the external buffer memory page size is 64 bytes, if each page is partitioned into 60 bytes by the interleaver, and if a packet-start data page that starts at page memory location X is 120 bytes, the request generator may create two write processor requests corresponding to two 60-byte sections, with the first section beginning at location X and the second location beginning at location X+60. Depending on the valid on control fields of the modified header descriptor, more complex conversions may be performed by the request generator 116. For example, the write processor 118 may also modify the memory address locations 812, 814 and the valid and drop fields 806, 808, 810, in order to properly partition both the modified header data and the original packet-start page data, and then merge these partitions into multiple valid packet-start pages. This merging process is further described in detail below.

Once the write processor requests for the packet-start pages have been generated and sent, the request generator 116 retrieves the next data descriptor from the page descriptor FIFO 216. If the data descriptor corresponds to the same interface as a previously processed packet-start page, then the page is checked to determine its type. If the packet is not a packet-start page, then the request generator 116 issues as many read requests as are designated by the replication count associated with the interface of the given packet 720. If the packet is a packet-end page, then the request generator 116 again issues as many read requests as described above, and also proceeds to reset the corresponding replication count to an initial value of one 726. However, if the data descriptor indicates a packet-start page, then the system may recognize that an error has occurred and invoke an error-recovery, or clean-up, process 708. The presence of a packet-start page in an interface stream prior to a packet-end page may indicate that a physical error was encountered at the interface paging system 706, resulting in the subsequent data pages from a data stream being dropped from the system, including the packet-end page for the specific data packet. The error-recovery process may take several forms and is discussed in more detail below.

The write processor 118 receives the read requests from the request generator 116. In addition, the write processor 118 communicates with the free list manager 138 of the external memory 130 in order to determine memory channel capacity, overall free memory space in the external buffer memory, and free external buffer memory page locations. With this information, the write processor 118 may select which memory channel or channels to utilize for writing data segments to the external memory 130. In general, data segments from the same data packet copy (having the same unique tag identifier) may be written sequentially on a single channel. Alternatively, data segments may be written using multiple channels or across several channels. Using information contained in the request generator 116 along with the state of the external memory space and data channels, the write processor 118 can then issue a simple service request to the service module. FIG. 9 illustrates the composition of a service request message 900 according to one embodiment. The service request may comprise information provided by the write processor request message 800 such as the TAG entry 902, the P_TYPE entry 904 (packet-start, modified header, packet-end, or packet-continuation), H_VALID entry 906, P_VALID entry 908, P_DROP entry 910, H_ADDR entry 912, P_ADDR entry 914, and LEN entry 916. In addition the service request may comprise a MEM entry 902 indicating the memory channel on which data should be written to the external memory buffer. In creating service requests to write data to the external memory buffer 130, the write processor 118 may also aid in organizing data segments corresponding to write requests with similar tag identifiers into a data structure.

In one embodiment, the write processor 118 may arrange the data segments into a single-linked list. This may be accomplished by keeping a list of memory pointers in a tag memory structure 120. Each unique tag identifier may be associated with three pointer entries: a “current” pointer (W_ADDR) entry corresponding to a first external buffer memory location to which data from a write request with the given unique tag identifier will be written, a “link” pointer (LINK_PTR) entry corresponding to a second external buffer memory location to which data from the subsequent write request with the same unique tag identifier will be written, and a “head” pointer that links to the packet-start page location in the external memory. Once a memory channel is assigned to a data page and a corresponding service request is generated, the write processor 118 may retrieve the pointer information stored in the tag memory that corresponds to the tag identifier of the given data page. This pointer information may be formatted into a write configuration packet and then sent to an array of M FIFO queues 132, where M is the number of memory channels. The write configuration packet may then be input into the specific queue that corresponds to the memory channel that the given data page was assigned to. This write configuration packet may later be used to form the data page into a single-linked list, prior to the page being written to the external memory 130. The format of the write configuration packet is described in detail below. Once the information of a tag pointer entry has been read and formatted as a write configuration packet, the tag memory pointer entry may be modified as follows: the LINK_PTR entry may replace the W_ADDR entry and the write request may then select a new memory location for the new LINK_PTR entry based on the available memory pages in the external memory buffer 130. In general, the new LINK_PTR entry may specify a sequential data page in the external memory buffer. Alternatively, the new LINK_PTR entry may specify a data page in a different device, bank, or row than the previous link memory pointer entry. As described above, a list of available memory pages in the external memory may be provided to the write processor 118 by a free list manager module 138, which may monitor the all writes to and reads from the external buffer memory.

The service requests generated by the write processor 118 may be sorted according to their assigned memory channel and then sent to a read service FIFO queue structure 122, where the read service FIFO queue structure 122 may comprise one or more read service FIFO queues. The write processor 118 may have direct connections to each of the M read service queues, where M is the number of external buffer memory channels; alternatively the write processor 118 may send the service requests to a decoder that examines the channel indicator of each service request and routes the service request to the appropriate read service queue. A read service module 124 may then poll these queues for waiting service requests to be processed. If a single queue contains requests, then the read service module 124 will attempt to service this queue until the queue is empty or until other queues begin to fill with requests. If multiple read service queues contain requests, the read service module may perform a round robin on the queues 122 and attempt to process service requests as they become available. When the read service module 124 detects a service request in the read service queues 122, it may first determine if the central memory unit 114 is currently servicing read requests and then determine if the memory channel or channels that correspond to the service request are currently available. If a memory channel is not available, the read service module may instead attempt to process a service request from a read service queue that corresponds to a different memory channel. If both the central memory unit 114 and the corresponding memory channel are currently available, the read service module 124 may generate a read request from the service request and send it to the central memory unit 114. The read request may comprise such information as the location of data in the page memory or the modified header memory, the length of data to be read out, and the channel that is to be used to write the data to the external memory buffer. In the case of modified header data, the read request may also comprise control information for merging the modified header data with the corresponding original packet-start page data in order to create a final packet-start page that may be written to the external buffer memory. The read request may also comprise the unique TAG entry assigned to the data packet in the write process request, and the P_TYPE entry (packet-start, packet-end, or packet-continuation).

The read request may be received by the central memory unit 114, which may then processes the request. The memory controller retrieves the data segment of the length, memory location, and data memory (either the page memory 214 or the modified header memory 314) specified by the service request. In the case of packet-end pages and packet-continuation pages, this may involve retrieving data of the given length from the designated memory location in the page memory and outputting this data. In the case of modified header pages, this may involve retrieving data of the given length from the designated ocation in the modified header memory and outputting this data. In the case of a packet-tart page, this retrieval may comprise retrieving the original packet-start page from the age memory 214, retrieving the modified header from the modified header memory 314, merging the original and modified headers, and then outputting a final packet-start page. Once the data is retrieved, it is output to one of M external memory write queues 128; the data may be output directly to these write queues 128 or they may be sent with a channel identifier to a de-multiplexer that can decode the channel identifier and distribute the output data segments to the proper write queue.

Each data segment may subsequently be paired with a write configuration packet previously generated by the write processor 118 so as to facilitate buffering the data segment into the buffer of the external memory 130. As shown in FIG. 10, this write configuration packet 1000 may comprise information stored in the tag memory 120 for the unique tag identifier of the data segment, such as an W_ADDR field 1006 that represents the address where the data segment is to be written, and a LINK_PTR field 1008 that represents a pointer to sequentially data in the single-linked list data structure. The write configuration packet may also comprise a P_TYPE field 1002 that designates the type of page (packet-start, packet-end, packet-continuation) to which the write configuration packet corresponds, and a LEN field 1004 that indicates the overall length of the data segment.

Once the data from the central memory unit 114 has been read out to the external memory queues 128, it may be sent to a control structure 128 that directs input to each of the M external buffer memory channels. The control structure 128 may be implemented by a series of M multiplexers which may select input from either the external memory queues 126 or the write processor 118. Data sent to the control structure 128 from the external emory queues 126 includes data segments retrieved from the modified header memory 314 and the page memory 214. Data sent to the control structure 128 from the write processor 118 may include external write configuration packets. When a data segment is received from the buffer memory queues 126, the control structure may retrieve the next write configuration packet from the corresponding queue in the array of write configuration packet queues 132. The control structure 128 may modify the data segment by appending the LEN data from the write configuration packet to the data segment. Additionally, the control structure may also modify append the LINK_PTR entry to the data segment, thereby creating linked data structure nodes according to a given data structure scheme. For example, if the system utilizes a single-linked list data structure scheme for linking data segments in memory, the control structure 128 may append the LINK_PTR contained in the write configuration packet to the end of the data segment, except in the case where the data segment is a packet-end. Alternatively, this data segment modification may take place in the memory controller of the external memory 130. In this embodiment, the control structure 128 forwards any received data segments and write configuration packets to a controller in the external memory 130, which then processes the configuration packets and writes the modified data segments into the buffer of the external memory.

3. Merging Packet-Start Pages

As discussed above, modified headers may be merged with original packet-start pages in order to create a final set of start pages that may be written to the external buffer memory. This merging process requires several different steps which may occur throughout the buffering process.

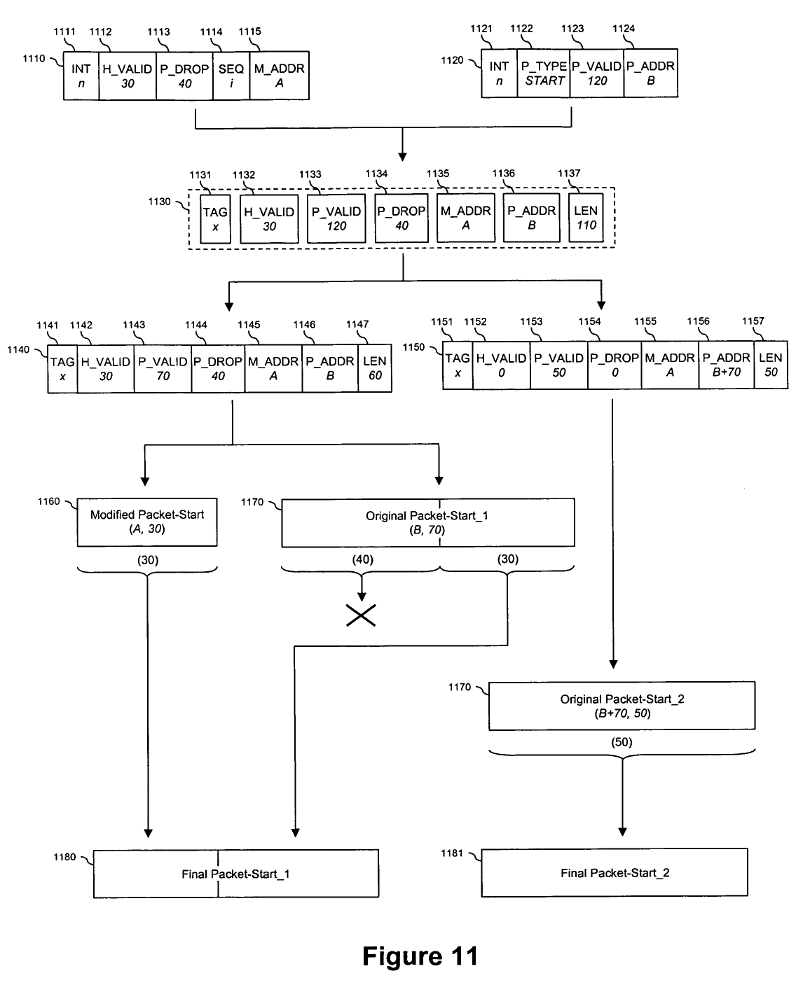

FIG. 11 illustrates a process by which modified and original packet-start pages may be merged. The merging process may begin with the request generator retrieving a packet-start descriptor 1120 from the page descriptor FIFO and then merging the information contained in this descriptor with a corresponding modified header descriptor 1110 in the modified header descriptor FIFO. The request generator may utilize the P_ADDR 1124 and P_VALID 1123 fields of the page descriptor 1120, and combine this information with the H_VALID 1112, P_DROP 1113, and M_ADDR 1115 fields of the modified header descriptor 1110. With the addition of an assigned tag value, this combination may result in a pseudo write processor request 1130. A TAG entry is assigned by the write processor, and a new LEN entry 1137 is generated to correspond to the data segment defined by the pseudo write request. Additionally, the request generator may also extract additional data values such as the P_TYPE field 1122, which may correspond to a packet-start page in this example. The combined information of the two page descriptors in FIG. 10 describes a pseudo request 1030 for a modified header having a TAG 1131 of X, a H_VALID entry 1132 of 30 bytes, a P_VALID entry 1133 of 120 bytes, a P_DROP entry 1134 of 40 bytes, a M_ADDR entry 1135 of A, a P_ADDR entry 1136 of B, and a LEN entry 1137 of 110 bytes. The overall length designated by the LEN entry takes into account that a total of 10 bytes are lost from the original 120-bytes length, since 40 bytes are dropped from the original packet while only 30 bytes are added by the modified header.

Since the size of the modified header may be substantially larger than the page size of the external buffer memory, the write processor may divide the single write processor request into two or more separate service requests. In the example of FIG. 10, the external memory page size is 64 bytes, and as a result the pseudo request for the 110-byte modified header must be divided into two separate write processor requests 1140, 1150 for a 60-byte page 1180 and a 50-byte page 1181, corresponding to a first portion and second portion of the pseudo 110-byte page. As a result, the two LEN entries 1147, 1157 of the first 1140 and the second 1150 service requests have modified values of 60 and 50 bytes, respectively.

With respect to the first write processor request 1040, the partitioning of the pseudo request is mainly accomplished through modifications to the P_VALID 1133, and LEN 1137 entries. If the value of the H_VALID entry 1132 of the pseudo request is less than the maximum size of a data page, then all of the valid modified header data may be included in the initial write processor request 1140; any remaining space for the page described by the initial write processor request may comprise data from the corresponding page data entry described by the page descriptor 1120. In the example of FIG. 10, the number bytes in the H_VALID entry 1132 of the pseudo write processor request 1020 is less than the 60-byte page maximum; as a result all 30 bytes of the modified header page are included in the first service request 1140, and is reflected in the H_VALID entry 1142 of the first service request 1140. The remaining 30 bytes of the 60-byte page 1180 are taken from the original packet-start data from the page memory. Since the P_DROP entry 1134 of the pseudo request indicates that the first 40 bytes of the original 120-byte packet are to be dropped, the initial 70 bytes of the total 120 bytes in the original packet-start data must be retrieved, giving a P_VALID entry 1143 value of 70. When these 70 bytes of page data are retrieved, the initial 40 bytes will be dropped leaving 30 bytes of page data. In combination with the 30 bytes of retrieved header data, this correctly provides a total of 60 bytes to be combined to form the first portion of the final packet-start data segment, which is reflected in the LEN value 1147.

The second write processor request 1150 also requires modification of the values in the P_VALID 1133 and LEN 1137 fields in order to account for the partitioning of the pseudo write processor request. Additionally, the second write processor request 1150 requires changes to the values in the P_ADDR 1136 and H_VALID 1132 entries. In order to retrieve the second portion of the page data from the memory, the P_ADDR field 1136 must be offset by the length of data previously retrieved from the page data entry, or the value of the P_VALID field 1143 of the first service request 1040. In the example of FIG. 11, this provides a P_ADDR field 1156 of B+70. If the entire modified header entry is incorporated into the first write processor request 1140, then no header data needs to be retrieved and may be reflected in a H_VALID field 1152 value of 0. In this example shown in FIG. 11 the second write processor request is directed to retrieving the remaining data in the page memory entry. The remaining data in the page memory entry is simply the total amount of valid page data as designated by the P_VALID entry 1123 of the page descriptor 1120 less the amount of data retrieved by the first write processor request, or the P_VALID entry 1133. In the current example, the remaining amount of page data is 50 bytes and is reflected in the P_VALID entry 1153. Additionally, the LEN field 1157 is modified to reflect the length of the modified header data and page data designated by the second service request. In the current example, no data is retrieved from the header, giving a LEN entry 1157 equal to the P_VALID entry 1153.

Once the write processor requests have been generated by the request generator 116, they are sent to the write processor, assigned a memory channel and formed into separate service requests (not shown), forwarded to the read service module 124, and then sent to the central memory unit 114. The service requests are essentially the same as the write processor requests from which they derive, but with the addition of a M_CHAN field to designate the assigned memory channel for the buffering transaction. Each of these service requests may potentially generate a request for data from the modified header memory 314 and the page memory 214. The data request for the modified header memory and the page data memory each generally include a memory address and a length of data to be retrieved. The modified header data service request also includes the H_VALID entry value, which instructs the modified header memory to keep only H_VALID bytes in the retrieved modified header. Likewise, the page data memory request includes both the P_VALID entry and the P_DROP entry, which instruct the page data memory to only retrieve P_VALID bytes from the original packet-start page entry, and to subsequently drop P_DROP bytes from the initial portion of this retrieved data. The dropping of specific retrieved data and the merging of separate data segments from the page and modified header memories may take place in a separate merging module 606 within the central memory unit 114. This merging module may make use of the H_VALID, P_VALID, and P_DROP values to correctly merge data segments into a single segment. After being combined, the remaining data from the retrieved portions of the modified header and the original packet-start pages may compose a single final packet-start page that corresponds to one partition of the final packet-start page.

As shown in FIG. 11, the service request corresponding to the first write processor request 1140 results in the retrieval of 30 bytes of data from the modified header memory location A. Additionally, 70 bytes of original packet-start data are retrieved from page memory location B, with the initial 40 bytes of this data being dropped; the remaining 30 bytes of original packet-start data are then combined with the 30 bytes retrieved from modified header memory location A to create a single 60-byte data segment 1180 that represents the first portion of the final packet-start data page. The service request corresponding to the second write processor request 1150 results in the retrieval of the last 50 bytes of valid data from the original packet-start data page located at page memory address B+70. These 50 bytes then compose the second portion 1182 of the final packet-start data page. These two segments 1180, 1181 are then output to the external memory queues 128 and are subsequently formed into a single-linked list before being written to the external memory.

4. Retrieving Buffered Data

Once a write processor request corresponding to a packet-end page is processed by the write processor, the memory location assigned to the corresponding packet-start page (the header pointer for the data packet) may be inserted into a FIFO queue 134 to indicate that the data packet is available to be read out of the memory. This FIFO queue may output entries to a quality-of-service provider, or scheduler 136. In general the scheduler may determine when the data packet designated by the header pointer should be read out of the memory. In one embodiment, supplemental information may be provided to the scheduler 136 by the write processor 118 in order to more efficiently schedule the reading of data packets from the external memory buffer 130. This supplemental information may be provided concurrently with the head pointer and may comprise the incoming or outgoing port for the data packet, or any other type of information that may be utilized by the scheduler to determine the priority of the packet and when it should be scheduled. For example, a second packet that is received by the scheduler 134 after the first packet may be scheduled to be read first if it maintains a outgoing port with a substantially higher priority over the first packet.

Once the scheduler module 136 has selected a data packet for reading, the header pointer of the data packet and any supplementary information may be passed to a read processor 140. The read processor may then retrieve the packet-start page from the external memory and send the page to an output buffer; the read processor also strips the link pointer from the packet-start page and then retrieves the next page in the packet from the external memory. The read processor continues the iterative process of retrieving a page, sending the data in the page to an output buffer, and extracting the link pointer to the next page of the packet until all data pages corresponding to a given data packet have been retrieved from memory. For each data page that is retrieved from the external memory 130, the read processor 140 may send a corresponding message to the free list manager 138 to facilitate the tracking of free pages in the external memory.

5. Central Memory Free Space Management

Once the data has been read out of the central memory unit 114 and into the external memory write queues 126, the page memory controller may determine whether the space occupied by the data should be freed or not. Data pages from the same data packet are always written sequentially into the page memory, due to the streaming nature of the interleaver unit. However, because the write processor may assign write requests for data pages to several different memory channels, the data pages may not be read out of the page memory in order. Because the read service module checks for the availability of memory channels prior to processing service requests, it is possible for the read service module to issue read requests for data pages in an order that is different from the actual sequence of data pages in the page memory. Hence there is no guarantee that the memory space in either the page memory 214 or the modified header memory 314 is freed sequentially. As a result, separate structures may be utilized to monitor the status of each data page in the page data memory and the modified header memory, respectively.

In one embodiment, two separate bitmap memories may be utilized to this effect. A page bitmap memory 612 may comprise a single entry corresponding to each data page of the page memory 214, where the entry is a count of the number of instances of the data page that need to be written to the external memory 130. Each entry in the page bitmap memory may be incremented for each write processor request generated by the request module 116 for the corresponding data page. Subsequently, an entry in the bitmap memory may be decremented each time data from the data page is read out of the page memory 214. Using this method, it can be determined that a data page is free when the associated bitmap memory count is zero, and that the data page should not be overwritten if a value greater than zero is indicated. In another embodiment, each entry in the page data bitmap memory may comprise a flag bit along with one or more count bits. The count bits may be used to keep track of the number of outstanding requests for the data page, while the flag bit may be used to indicate whether the page is free or in use. For example, each bit memory entry structure may comprise four bits, with a single bit as the flag bit, along with three bits utilized to maintain a count.

A modified header bitmap memory 602 may operate in a similar fashion to the page bitmap memory 612. However, the modified header bitmap memory may comprise only a single flag bit corresponding to each page entry in the modified header memory 314. Because a modified header can only correspond to a single copy of packet data, it may only be read out of the memory once. Therefore the flag bit for a modified header entry may be set when a write processor request for the modified header is created by the request generator module 116. This flag bit may then be cleared when the corresponding modified header is read out of the modified header memory.

6. Error Handling

Due to the streaming nature of the current system, the actions related to error recovery are not limited in scope to the components of the system and may require adjustments to the recovery buffer. In general a data packet that has been corrupted during transfer to the router may not be established as being corrupt until after data from the packet has been stored in the external memory 130. As described above, physical errors in a data packet due to transmission problems generally result in subsequent data pages for the data packet being dropped at the interface page formation components 104. As a result, the data packet will not contain a corresponding packet-end data page. This missing packet-end data page is generally detected by the request generator 116. Depending on the length of the packet, the turnaround time for data stored in the page memory, the processing speed of the external header processor 110, and various other factors, by the time this error has been detected by the request generator 116 several data segments of the data packet may have been retrieved from the page memory and written to the external memory 130.

If the error is detected early enough in the streaming process and no corrupted data has been written to the external memory 130, then the error recovery process may only require changes to data stored in the central memory unit 114. In this limited case, the request generator 116 may drop all modified header data associated with the corrupted data packet and may direct the page memory 214 to free any memory containing data pages associated with the corrupted data packet. Freeing the space in the page memory 214 and modified header memory 314 may be accomplished by modifying the entries in the bitmap memories 602, 612 that correspond to the data pages of the corrupt packet in order to indicate that the page memory locations are free. The bitmap memory entries may be modified as a result of control signals generated by the request generator 116. Alternatively, the bitmap memory entries may be modified through drop packets generated by the write processor 118 and passed through the read service module 124 to the page memory. These drop packets may provide instructions for the central memory unit 114, and subsequently the two bitmap memories 602, 612, to free specified memory locations.

However, if the error is not detected prior to corrupted data being written to the external memory buffer 130, then the recovery process may require additional steps above the page memory modifications. Any corrupted data must be removed from the external memory 130 with the associated external buffer memory pages being freed. When the request generator 116 detects an error in a data packet, the write processor 118 may be notified of the error. The write processor may determine the tag identifier (or tag identifiers in the case of a multicast packet) corresponding to the corrupt data packet and may then retrieve the associated header pointer (or pointers) from the tag memory 120. In one embodiment, these header pointers may then be passed to the scheduler 136 with an indication that the corresponding packet data is corrupt and should be summarily dropped. In an alternative embodiment, the write processor may have a link to a FIFO that directly outputs data into the read processor 140; the write processor may then pass the header pointers corresponding to the corrupt data packets to this FIFO, where the read processor may summarily examine these header pointer for the corrupt packets, retrieve the data pages of the corrupt packets from the external buffer memory, and then free the associated external buffer memory pages. In this embodiment, consideration must be given to the possible race condition that exists between the process of writing corrupt data to the external buffer memory and the process of freeing this data. If the data pages are freed by the read processor prior to the corrupt data actually being written to memory, the system may be adversely affected and may invoke a scenario where corrupt data remains latent in the external buffer memory and valid data is inadvertently dropped from the buffer. As a result, an artificial delay may be introduced into the path between the write processor and the read processor to insure enough latency to avoid this race condition.

7. Conclusion

Exemplary embodiments of the present invention relating to a streaming buffer system for a router or switch have been illustrated and described. It should be noted that more significant changes in configuration and form are also possible and intended to be within the scope of the system taught herein. For example, communication between modules in shown in the diagrams is not limiting, and alternative lines of communication between system components may exist where explicitly stated or implied. In addition individual segments of information present in request and configuration packets passed between system components may be ordered differently than shown in accompanying diagrams, may not contain certain unnecessary segments of data, may contain additional data segments, and may be sent in one or more sections.

It should be understood that the programs, processes, methods and apparatus described herein are not related or limited to any particular type of processor, computer, or network apparatus (hardware or software), unless indicated otherwise. Various types of general purpose or specialized processors, or computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope and spirit of the present invention. For example, the steps of the flow diagrams may be taken in sequences other than those described, and more, fewer or other elements may be used in the block diagrams. The claims should not be read as limited to the described order or elements unless stated to that effect.

We claim:

1. A method for buffering a data packet in a digital communications network, the method comprising:
receiving one or more data packets, wherein each packet is received at one interface of a plurality of interfaces, and wherein each data packet comprises a header;
paging each data packet into one or more data pages, the one or more data pages comprising a start data page, wherein the start data page comprises the header;
storing the data pages in a page memory;
processing the header and returning one or more modified header pages;
reading the data pages from the page memory for each of the one or more modified header pages; and
writing the data pages and the associated one or more modified header pages to an external memory using one or more external memory channels.

2. The method of claim 1 wherein each data packet corresponds to a data stream, and further comprising:
checking for physical errors in data packets received at the interface; and
dropping subsequent packets in the corresponding data stream if a physical error is detected in a data packet.

3. The method of claim 1 further comprising interleaving the data pages of each of the one or more data packets after paging each data packet, wherein the data pages are interleaved in the order in which they are paged, and wherein the data pages are stored in the page memory in the order in which they are interleaved.

4. The method of claim 1 wherein the headers are processed in the order in which they are paged, and wherein the modified header pages that are returned preserve the order of the header pages.

5. The method of claim 1 further comprising associating a tag identifier to each modified header page and its corresponding data pages.

6. The method of claim 5 further comprising maintaining a tag descriptor associated with each tag identifier, wherein the tag descriptor comprises the location in the external memory where a current page associated with a tag identifier is to be written, and the location in the external memory where the page associated with the tag identifier that precedes the next page is to be written.

7. The method of claim 6 wherein the tag descriptor further comprises a header pointer.

8. The method of claim 1 further comprising maintaining a bitmap memory that tracks whether each page in the page memory is free or used through a process comprising:
keeping a count of a number of requests currently pending for a page;
initializing the count for each page to zero;
incrementing the count for each returned modified header associated with that page;
decrementing the count for each time the page is read out of memory; and
determining that a page is free when the count is zero, and that a page is used when the count is greater than zero.

9. The method of claim 1 wherein the process of reading data pages from the page memory comprises:
sequentially examining page descriptors, wherein each page descriptor corresponds to a data page in the page memory;
determining whether each page descriptor corresponds to a data page that is either a packet-start, a packet-end, or a packet-continuation;
processing a packet-start data page by retrieving all modified headers corresponding to the header of the data packet of the packet-start data page, maintaining a count K of the number of retrieved modified headers, and generating K read requests for the packet-start data page;
processing a packet-end by generating K read requests for the data page;
processing a packet-continuation by generating K read requests for the data page; and
processing the read requests to retrieve data from the page memory.

10. The method of claim 9 wherein the count K uniquely corresponds to an interface, and wherein processing the packet-end data page further comprises clearing the count K.

11. A method for reading data pages from a page memory comprising:
sequentially examining page descriptors, wherein each page descriptor corresponds to a data page in the page memory, and wherein each data page belongs to a data packet;
determining whether a page descriptor corresponds to a data page that is either a packet-start, packet-end, or a continuation;
processing a packet-start by retrieving all modified headers corresponding to data packet of the packet-start, maintaining a count K of the number of retrieved modified headers, and generating K read requests for the data page;
processing a packet-end by generating K read requests for the data page;
processing a packet-continuation by generating K read requests for the data page; and
processing the read requests to retrieve data from the page memory.

12. The method of claim 11 wherein each data packet is received over an interface, and wherein the count K is unique to the interface.

13. The method of claim 11 wherein processing the end-of-packet data page further comprises clearing the count K.

14. A method for processing headers in data packets, the method comprising:
receiving a series of original headers;
assigning an initial sequence number to each original header;
generating one or more modified headers for each original header;
assigning a header sequence value to each modified header, wherein the header sequence value is equal to the initial sequence number assigned to the associated original header;
determining whether a modified header corresponds to a valid or invalid data packet;
discarding header sequence values assigned to modified headers corresponding to invalid data packets; and
returning a series of header sequence values, wherein the sequence comprises the set of remaining header sequence values.

15. The method of claim 14 wherein the initial sequence numbers preserve the order of the series of original headers.

16. The method of claim 15 further comprising:
examining the series of header sequence numbers;
determining a set of gap sequence values, wherein the gap sequence values correspond to missing header sequence number values in the series of header sequence values; and
dropping data packets associated with modified headers to which the set of gap sequence values have been assigned.

17. The method of claim 15 wherein a multiple of modified headers are returned for an original header that is a multicast header.

18. The method of claim 17 wherein a set of modified headers corresponding to a single multicast header are assigned the same header sequence value.

19. A method of recovering from errors in a streaming packet buffering system, the method comprising:
receiving a series of page descriptors, wherein each page descriptor comprises a tag identifier and a page type;
examining the sequence of page type values for page descriptors having the same tag identifier value;
determining that a tag identifier is a corrupt tag identifier if the sequence of page type values for the tag identifier comprises a packet-start page type value that does not immediately follow a packet-end page type value, wherein the corrupt tag identifier designates a corrupt data packet; and
dropping the corrupt data packet.

20. The method of claim 19 wherein dropping the data packet designated by the corrupt tag identifier comprises:
retrieving a head pointer corresponding to the corrupt tag identifier;
sending the head pointer and a drop signal to a read processor; and
utilizing the head pointer to drop the corrupt data packet from an external memory.

21. A system for buffering data packets over a digital communications network, the system comprising:
an interleaver that interleaves data pages;
a header processor that receives data pages from the interleaver and generates modified headers;
a page memory that stores data pages received by the interleaver, and reads out data segments;
a header memory that stores modified headers from the header processor;
a request generator that organizes data pages and modified headers into data segments, and generates write requests for data segments from the page memory and the header memory;
a write processor that receives write requests from the request generator, generates service requests for the data segments, generates write configuration packets, and forwards modified headers from the request generator;
a service request module that receives service requests from the write processor and requests the data segments from the page memory and header memory; and
a control structure that receives data segments from the page memory and header memory, receives write configuration packets from write processor, and forwards data segments and to an external memory.

22. The system of claim 21 further comprising one or more external memory queues that receive data segments from the page memory and header memory, and send the data segments to the control structure.

23. The system of claim 21 further comprising one or more read service queues that receive service requests from the write processor and sends the service requests to a service request module.

24. The system of claim 21 further comprising a tag memory, wherein the request generator assigns a unique tag descriptor to each modified header, and wherein information associated with each tag descriptor is stored in the tag memory.

25. The system of claim 21 wherein the data pages each correspond to a data packet, wherein each data packet correspond to a data stream, and wherein each data packet comprises a header and a data payload.

26. The system of claim 21 wherein each write configuration packet comprises a length value, a write address, and a link pointer.

27. The system of claim 26 wherein the control structure appends the link pointer data from write configuration packets to data segments, and forwards the length value and write address of the write configuration packet to the external memory.

28. The system of claim 21 further comprising one or more port interfaces that receive data packets from a network, wherein each port interface pages each data packet into one or more data pages, the one or more data pages comprising a packet-start page, wherein the packet-start page comprises a header.

29. The system of claim 28 wherein the header processor returns one or more modified header descriptors to the request generator, wherein each modified header descriptor corresponds to a modified header.
